(19) United States
(12) Patent Application Publication
(10) Pub. No.: US 2015/0330862 A1
(43) Pub. Date: Nov. 19, 2015

(54) APPARATUS AND METHOD FOR DIESEL ENGINE CHECK TOOL

(71) Applicant: Michael A. Pickard, Muskegon, MI (US)

(72) Inventor: Michael A. Pickard, Muskegon, MI (US)

(21) Appl. No.: 14/715,723

(22) Filed: May 19, 2015

Related U.S. Application Data
(60) Provisional application No. 62/000,252, filed on May 19, 2014.

(51) Int. Cl. G01M 3/02

(52) U.S. Cl. CPC G01M 3/025

(57) ABSTRACT

A method for detecting leaks in a diesel engine is disclosed. The method includes connecting a nozzle of a leak testing device to a threaded inlet of the engine. The threaded inlet is in fluid communication with a high pressure oil cavity of the engine. A hose in fluid communication with the nozzle is connected to a pressurized air source to pressurize the engine with pressurized air from the pressurized air source. With the engine pressurized, a technician listens for an audible sound identifying the pressurized air leaking from the engine. A location of the leaking is then identified based on the audible sound from the engine.

### CROSS-REFERENCE TO RELATED APPLICATION

This application claims priority to and the benefit under 35 U.S.C. §119(e) of U.S. Provisional Patent Application No. 62/000,252, filed May 19, 2014, entitled “METHOD FOR DIESEL ENGINE CHECK TOOL,” the entire disclosure of which is hereby incorporated by reference in its entirety.

### BACKGROUND

In modern diesel engines, ensuring the integrity of oil systems is imperative to maintaining performance and preventing failures. Though repairing leaks of engines can be challenging and costly, even more troubling can be identifying locations of the engine from which oil pressure is being lost. The apparatus and methods described herein provide a novel approach to identifying a location of a leak in fluid communication with an oil system in a diesel engine.

### SUMMARY

In one aspect of the present disclosure, a method for detecting leaks in a diesel engine is disclosed. The method includes connecting a nozzle of a leak testing device to a threaded inlet of the engine. The threaded inlet is in fluid communication with a high pressure oil cavity of the engine. A hose in fluid communication with the nozzle is connected to a pressurized air source to pressurize the engine with pressurized air from the pressurized air source. With the engine pressurized, a technician listens for an audible sound identifying the pressurized air leaking from the engine. A location of the leaking is then identified based on the audible sound from the engine.

These and other features, advantages, and objects of the present disclosure will be further understood and appreciated by those skilled in the art by reference to the following specification, claims, and appended drawings.

### BRIEF DESCRIPTION OF THE DRAWINGS

FIG. 1 is a perspective view of a leak testing device for identifying a location of a leak;

FIG. 2 is a front perspective view of a nozzle for a leak testing device;

FIG. 3 is a rear perspective view of a nozzle for a leak testing device; and

FIG. 4 is a block diagram of a method for utilizing the leak testing device to identify a location of a leak.

### DETAILED DESCRIPTION

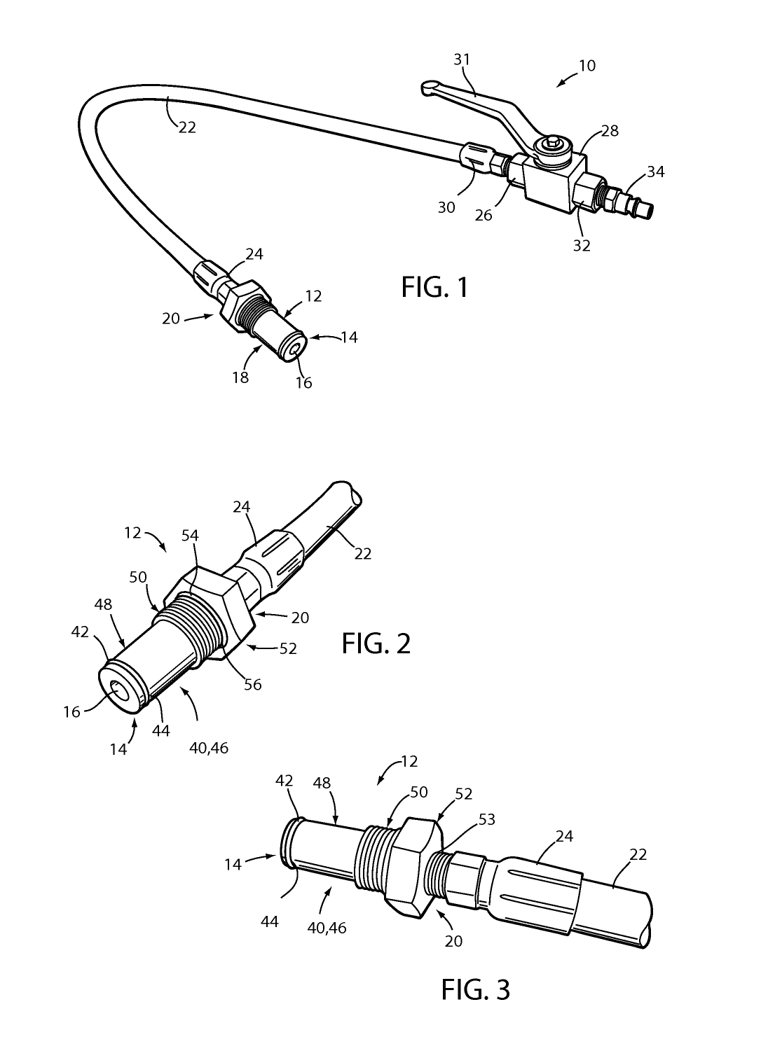

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIG. 1, reference numeral 10 generally designates a leak testing device or testing device 10 for identifying a point of origin of an aperture causing a pressure loss from an oil system in a diesel engine. The pressure loss may result in diminished performance due to inefficient engine operation and may lead to failure of engine operation. The leak testing device 10 is configured to connect to a port or threaded inlet to test for a loss of oil pressure from a pressurized oil cavity within the diesel engine. Once connected to the threaded inlet, the testing device 10 forms a sealed assembly with the oil cavity. The testing device 10 is then utilized to pressurize the oil cavity and an interconnected oil supply system in the diesel engine.

The testing device 10 is configured to communicate pressurized air into the oil cavity and the interconnected oil supply system to pressurize the oil cavity. Once the oil cavity is pressurized, an aperture causing the pressure loss from the oil system will create an audible sound, for example, a hissing noise. The aperture may comprise an opening, crack, leak, or any other breach in the oil system allowing pressure loss. By following the audible sound emitted from the origin of the pressure loss or pressure breach on the engine, the location of the aperture and cause of the pressure loss from the engine may be identified. The apparatus and methods described herein provide for a novel approach to inexpensively and safely identifying a location of pressure loss in a diesel engine for diagnostics and repair.

The testing device 10 comprises a nozzle 12 configured to engage the threaded inlet of the diesel engine. The threaded inlet is in fluid communication with the diesel engine, and in specific engine designs, may be configured to connect a high pressure regulator to the engine. During engine operation, the high pressure regulator may be operable to monitor and control the internal engine pressure of an oil pressure system. The oil pressure system utilizes engine oil for pressurization of a fuel injector to compress diesel fuel in the fuel injector for combustion. Such an oil pressure system may be prone to leaks, leading to oil pressure loss that causes various defects in the operation of the engine. The testing device 10 may be configured for leak testing the following diesel engines: Ford 4.5 Liter Engine, Ford 6.0 Liter Engine, International Model vt275, and International Model vt365. Though specific models of diesel engines are described herein, the disclosure may be applied to a variety of engines and should not be considered limited to the specific examples listed herein. The testing device 10 and methods described herein may be utilized for diagnostics and testing of a variety of engines as will be understood by those having skill in the relevant art.

In some engines, the threaded inlet may be referred to as a high pressure oil pump aperture or a high pressure oil pump cover of the engine. Though particular connections are referred to herein, the nozzle 12 may be configured to pressurize an oil system for a variety of diesel engines through similar inlets. In an exemplary implementation, the threaded aperture can be accessed quickly to connect the testing device 10 to the oil system. In such implementations, the testing device 10 may be utilized to quickly initiate diagnostic testing for an engine.

The nozzle 12 comprises a first end portion 14 configured to engage the threaded inlet in a sealed configuration. Proximate the first end portion 14, the nozzle 12 forms a cylindrical opening 16 leading to an internal passage 18 for fluid communication with a pressurized air source. The pressurized air source may comprise a traditional pressurized shop air supply or any other form of pressurized air source. The pressurized air source may be configured to supply pressurized atmospheric air, a pressurized inert gas, or other gases through the internal passage 18 of the testing device 10.

Proximate a second end portion 20, the nozzle 12 forms a sealed connection with a hose 22 via a first fitting 24. The hose 22 is further connected to an outlet 26 of a valve 28 via a second fitting 30 configured to form a sealed connection between the hose 22 and the valve 28. The valve 28 further comprises a handle 31 configured to control a passage of a fluid, for example, pressurized air, through the valve 28. At an inlet 32, the valve 28 is in connection with a supply fitting 34 configured to connect the testing device 10 to the pressurized air source. The internal passage 18 of the nozzle 12 extends through the hose 22, the valve 28, and the supply fitting 34 to create a sealed passage for pressurized air to pass into the oil system of a diesel engine.

The hose 22 may comprise a high pressure hose for communication of pressurized air. The valve 28 may comprise an orbital ball valve or any form of valve mechanism configured to control air flow. The handle 31 of the valve 28 is configured to rotatably control the valve mechanism to selectively control the flow of pressurized air through the internal passage 18. The supply fitting 34 may comprise a quick connect air supply fitting commonly utilized to access a shop air supply. Though specific devices and fittings are discussed in reference to the testing device 10, various devices and configurations thereof may be utilized without departing from the spirit of the disclosure.

Referring now to FIGS. 2 and 3, perspective views of the nozzle 12 are shown. The nozzle 12 comprises a cylindrical profile 40 comprising a first seal 42 disposed in a channel portion 44. The channel portion 44 is disposed radially about the cylindrical profile 40 proximate the first end portion 14. An engaging surface 46 comprising a smooth shaft portion 48 and a threaded portion 50 is configured to rotatably engage the threaded inlet of the engine. When in connection with the threaded inlet, the internal passage 18 is configured to force pressurized air into the oil cavity of the engine.

Proximate the second end portion 20, the nozzle 12 comprises a hexagonal profile section 52. The hexagonal profile section 52 is configured to tighten the threaded portion 50 to seal the engaging surface 46 to the threaded inlet of the engine. The hexagonal profile section 52 forms a threaded inlet 53 configured to rotatably engage the first fitting 24. The engagement of the threaded inlet 53 to the first fitting 24 forms a sealed connection of the internal passage 18 extending from the nozzle 12 to the hose 22.

The nozzle 12 further comprises a second seal 54 disposed between the threaded portion 50 and the hexagonal profile section 52. The second seal 54 is retained in a gap 56 formed between the threaded portion 50 and the hexagonal profile section 52. When connected to the threaded inlet of the engine, the first seal 42 and the second seal 54 form a double seal interface between the engaging surface 46 and the threaded inlet. The double seal interface is configured to prevent pressurized air supplied from the pressurized air supply from escaping the testing device 10 and the pressurized oil cavity of the engine during leak testing. With the nozzle 12 sealed to the threaded inlet, the oil cavity and an interconnected oil supply may be tested for leaks.

The nozzle 12 may be formed from any form of metallic material, and in some implementations, may be formed of a corrosion resistant material. In an exemplary implementation, the nozzle 12 comprises a metal fitting plated in zinc. In various implementations, each of the several components of the testing device 10, as disclosed herein, may be partially or completely combined in various combinations to support the function of the testing device 10 without departing from the spirit of the disclosure.

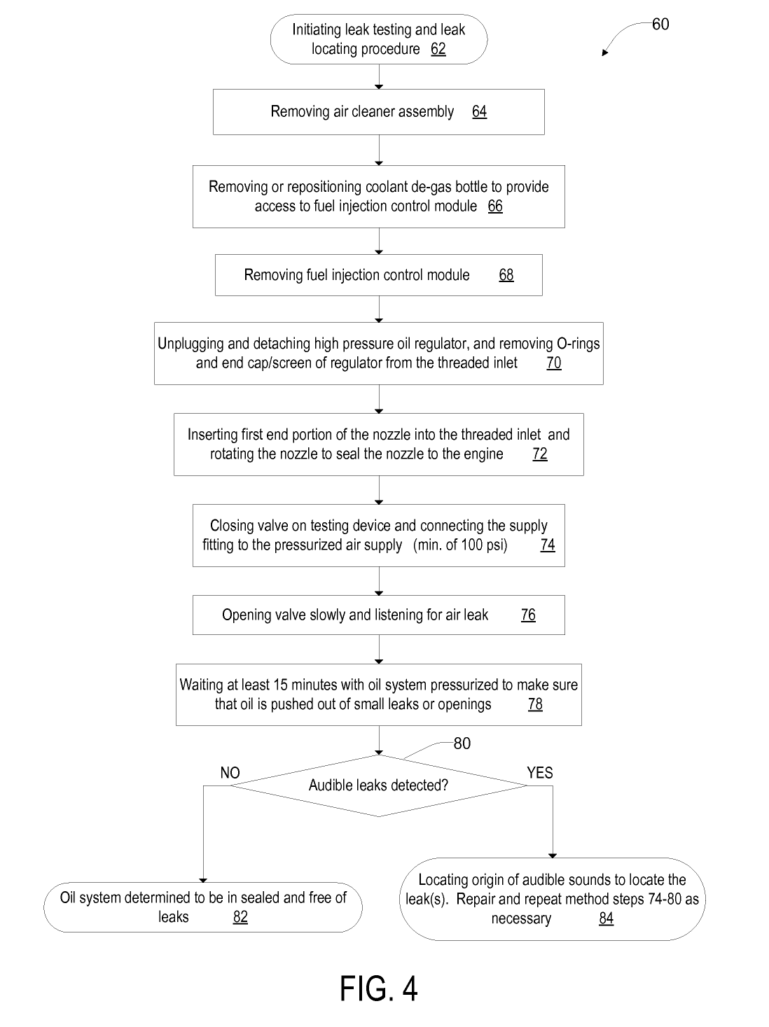

Referring now to FIG. 4, a flow chart of a method 60 for utilizing the leak testing device 10 to identify a location of a leak is shown. The method 60 may begin by initiating a leak testing and leak locating procedure (62). Before beginning the leak testing operation, the threaded inlet of the engine must first be accessible. Accessing the threaded inlet begins by removing an air cleaner assembly of the engine (64). With the air cleaner assembly removed, a coolant de-gas bottle is removed or repositioned to provide access to a fuel injection control module (66).

With the coolant de-gas bottle repositioned, the fuel injection control module is removed to provide access to the high pressure regulator, which is connected to the threaded inlet (68). Next, the high pressure regulator is unplugged from an engine control module and detached to expose the threaded inlet (70). With the high pressure regulator removed, the threaded inlet may also be checked for seals or O-rings and an end cap/screen of the high pressure regulator. If O-rings or the end cap/screen are found in the threaded inlet, they are removed to clear the threaded inlet for engagement with the nozzle 12.

Once the high pressure regulator is removed, the nozzle 12 is connected to the threaded aperture to begin leak testing with the testing device 10. The nozzle 12 is connected to the threaded inlet by inserting the first end portion 14 into the threaded inlet and rotating the nozzle 12 to seal the nozzle 12 to the engine (72). Prior to connecting the supply fitting 34 to the high-pressure air supply, the handle 31 of the valve 28 is rotated to a closed position. With the valve 28 closed, the supply fitting 34 is connected to the high-pressure air supply (74). The high-pressure air supply may have sufficient pressure to be utilized in the leak testing method 60 if the pressure is approximately greater than 100 pounds per square inch (psi).

With the testing device 10 connected to the high-pressure air supply and the threaded inlet of the engine, the valve 28 is slowly opened and a technician may begin listening for an air leak proximate the engine (76). The valve 28 is slowly opened by slowly rotating the handle 31, allowing the pressurized air from the pressurized air source to flow through the hose 22, into the nozzle 12, and into the engine to the oil cavity. With the valve 28 opened, the testing device 10 begins increasing the air pressure in the oil cavity. In some cases, a leak may be audibly detected almost immediately. In such cases, the leak may be sufficiently large that the engine oil does not block the leak. In other cases, a leak may not be immediately apparent upon pressurization of the oil cavity. In such cases, a leak may be small enough that the engine oil temporarily seals the leak.

For small leaks to be detected, the oil system cavity should be held in the pressurized state for at least 15 minutes to allow the engine oil to be forced from an aperture forming the small leak in the oil system cavity (78). Once the oil is displaced from the aperture, the pressurized air within the engine will begin to escape the oil system cavity forming an audible sound. In some instances, the oil system cavity may be held in a pressurized state for a much longer period of time, for example 2 or 3 hours. While the oil system cavity is in the pressurized state, the method 60 continues allowing a technician to listen for audible leaks (80).

If an audible leak is not detected, the oil system is considered to be sealed and free of leaks (82). As such, additional diagnostics may be utilized to identify other issues that may have limited performance of the engine. If an audible leak is detected, the origin of the leak is located by tracing the audible sounds emitted from the engine (84). By tracing a point of origin of the audible sounds created by the pressurized air escaping the engine, leaks in the oil system cavity may be identified for repair. Upon repair of a crack or aperture found to cause a leak, method steps 74-80 may be repeated to ensure that all leaks have been located and properly sealed.

The method 60 provides various benefits, including providing a safe, easy, and effective method to identify leaks in a diesel engine. The testing device 10 utilized in the method 60 may be configured for testing various engines to provide similar benefits to those discussed herein. Though specific components of the testing device 10 are discussed in detail herein, the components may be configured similar to those discussed herein to provide testing devices for various engines without departing from the spirit of the disclosure.

It will be understood by one having ordinary skill in the art that construction of the described disclosure and other components is not limited to any specific material. Other exemplary embodiments of the disclosure herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown in integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of the wide variety of materials that provide sufficient strength or durability, in any of the wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A method for detecting leaks in a diesel engine comprising:
connecting a nozzle of a leak testing device to a threaded inlet of the engine, the threaded inlet in fluid communication with a high pressure oil cavity of the engine;
connecting a hose in fluid communication with the nozzle to a pressurized air source;
pressurizing the engine with pressurized air from the pressurized air source;
listening for an audible sound identifying the pressurized air leaking from the engine; and
identifying a location of the leaking based on the audible sound from the engine.

2. The method according to claim 1, wherein the threaded inlet comprises a port configured to connect a high pressure regulator to the engine.

3. The method according to claim 2, wherein the port corresponds to a high pressure oil pump aperture.

4. The method according to claim 1, wherein the location is identified as a source from which the audible sound is emanating based on a volume of the audible sound.

5. The method according to claim 1, further comprising:
ensuring that a valve of the leak testing device is in a closed position prior to connecting the hose to the pressurized air source.

6. The method according to claim 5, further comprising:
pressurizing the engine by slowly opening the valve to pressurize the engine.

7. The method according to claim 1, wherein the pressurized air corresponds to atmospheric air.

8. A method for identifying leaks in an engine oil system comprising:
connecting a nozzle of a testing device to an oil pump inlet of the engine, wherein the oil pump inlet is in fluid communication with an oil cavity of the engine;
inputting air into the oil cavity through an internal passage of the nozzle;
pressurizing the engine with the air from the internal passage of the nozzle;
identifying a location of a leak emanating from a portion of the engine in fluid communication with the oil cavity based on a sound emitted from the engine.

9. The method according to claim 8, wherein the pressurizing the engine is initiated by opening a valve of the leak testing device.

10. The method according to claim 8, wherein the connecting of the nozzle comprises threading a threaded portion of the nozzle into a threaded inlet corresponding to the oil pump inlet.

11. The method according to claim 10, wherein the threaded portion of the nozzle and the threaded inlet form a sealed connection in an assembled configuration.

12. The method according to claim 8, further comprising:
supplying the air from a high pressure air source through the internal passage of the nozzle to input the air into the oil cavity.

13. The method according to claim 8, wherein the high pressure air source corresponds to an air supply having a pressure approximately greater than or equal to 100 pounds per square inch.

14. The method according to claim 8, further comprising:
accessing the oil pump inlet by removing a pressure regulator from the oil pump inlet.

15. The method according to claim 14, further comprising:
removing a fuel injection control module to access the pressure regulator.

16. A leak testing apparatus for a diesel engine comprising:
a first end portion forming a cylindrical opening configured to output air from a pressurized air source;
a second end portion forming a threaded inlet configured to form a sealed connection with a fitting, the fitting configured to connect to the pressurized air source;
an internal passage formed between the threaded inlet and the cylindrical opening, the internal passage configured to communicate the air from the second end portion to the first end portion; and
an engaging surface formed by the first end portion, wherein the first end portion is configured to sealably engage an oil pump inlet of the diesel engine.

17. The leak testing apparatus according to claim 16, wherein the engaging surface comprises a smooth shaft portion and a threaded portion.

18. The leak testing apparatus according to claim 17, wherein the threaded portion is configured to engage the oil pump inlet.

19. The leak testing apparatus according to claim 17, further comprising a first seal secured to a channel portion formed on the engaging surface proximate the cylindrical opening.

20. The leak testing apparatus according to claim 19, further comprising a second seal disposed between the threaded portion and a hexagonal profile section of the apparatus.
